(19) United States
(12) Patent Application Publication
(10) Pub. No.: US 2011/0145210 A1
(43) Pub. Date: Jun. 16, 2011

(54) System and Method for Managing One or More Databases

(75) Inventors: Ashok Prasanna Rathinam, Urbana, IL (US); Ramani Sivakumar, Aldie, VA (US)

(73) Assignee: NEGTI SYSTEMS, INC., Aldie, VA (US)

(21) Appl. No.: 12/634,844

(22) Filed: Dec. 10, 2009

(51) Int. Cl. G06F 17/30; G06F 7/00

(52) U.S. Cl. 707/705; 707/812; 707/805; 707/E17.005; 707/E17.044

(57) ABSTRACT

A system and method for managing one or more databases. A computing device includes a processor and memory device having stored therein a plurality of instructions which, in response to execution by the processor, cause the processor to connect to a first database, retrieve first metadata from the first database based upon a metadata retrieval policy, and store the first metadata as a first schema view of the first database in a unified data repository. The method is for managing a plurality of databases, where each database includes metadata having a plurality of database objects. The method includes receiving a request on a computing device to change at least one database object of a first database, then storing a tracking and number associated with the request, then comparing the metadata of the first database to metadata of a second database, then generating comparison data indicative of differences between the first database and the second database based upon the comparing step and, finally, verifying the comparison data based on the stored tracking number.

### BACKGROUND OF THE INVENTION

1. Field of the Invention

The invention relates to a system and techniques for database and data model repository management, access, search, compare and organization of database objects.

2. Description of the Related Art

The Relational Database Management Systems (“RDBMS”) is very commonly used to store any form of the data. There are many RDBMS available from many different vendors like Oracle, IBM DB2, Microsoft SQL Server, Terradata, MySQL etc. The data and the metadata (metadata is data about data) that are stored in the databases are accessed and managed by business users, business analysts, application programmers, database administrators, managers and others. The Structured Query Language (“SQL”) is mostly used to access the database and perform database related tasks. Database users and administrators connect to the databases and write SQL queries to access database catalogs to get information about metadata.

To access and manage these databases including data and its metadata, there are numerous database management software products and tools available. The software application tools in database management systems have become increasingly complex both in functionality and application platforms, i.e. too many application tools or platforms to perform everyday database management activities. Unfortunately, most of them have been used for years and not all the issues/concerns are addressed that are very important for modern day-to-day tasks performed by database users/administrators. A few of the issues are described in the following paragraphs.

a. Today's software applications must be able to help utilize the power of latest technology and enable people to accomplish their tasks easily. With increasing demand for skilled workers and associated cost, businesses can no longer continue to spend time and money on software that is just meant for highly skilled professional. This reduces both their competitiveness and ability to adapt to change in technology quickly.

b. Every database user and application developer tries to access a database and its metadata very frequently, increasing the need for databases available all the time which is achieved through many high availability techniques by the enterprises. But, none of the tools or systems allows database users to access the metadata even when the database/alternate databases are not available. None of the tools allows users to maintain their own copy of the metadata repository that will provide fast access of metadata and still be able to access when the actual database is not available and switch to real-time (live) mode as soon as it becomes available. This could greatly reduce server load, and improve performance and maintainability.

c. One additional challenge that exists in all software tools available is searching database objects. Traditionally software tool accepts a list of parameters (choices) to search and then connects to the database individually to retrieve and produce the information requested. This process could take several minutes for each request. In addition, this mechanism, which is widely used in all the database management tools, provides limited capability of what can be searched.

If database users wish to retrieve any metadata information from the databases, it requires expert level knowledge of those databases. Even experienced professionals often find it difficult and confusing when searching for database objects. Following are the some of the key issues that are being faced by the users:
1. Database users need to write complicated SQL queries and join multiple tables
2. Database users must remember dozens of tables, views and hundreds of columns and column values to search
3. Inability to search objects by non-technical users like analysts and managers without sufficient knowledge of different databases
4. Very primitive search features and slow response—could take many minutes in most cases.
5. No comprehensive search and results display for cross DBMS with advanced searching capabilities like, objects exclusions, expression search, keyword and web-like intelligent database search engines (like Yahoo or Google).

d. Another critical feature that most tools support is database comparing. The compare feature allows users to find differences between the database objects like tables, views, procedures, triggers etc.

While most of the tools satisfy traditional need to find differences and use those results to migrate (move) the changes to a different environment, they fall short on a few critical needs of today.
1. The ability to compare databases (including cross DBMS) and present it in a way that users view all of the compared databases in a horizontal and simple format that is easy to understand by everyone, not just technical users.
2. The ability to present comprehensive view of both differences and discrepancies—the database management software that is available today capable of producing only the differences between the structures, but none of them can differentiate between the difference and discrepancies. For example, a database change like a new table or column may exist in development database but not in test or production databases. This could very well be an approved development change pending migration. There might be another table or column change in development or test possibly created by user accidentally or during database structure or data refresh. The earlier one is a difference but the later one is discrepancy. The challenge for any database users or project manager is to make sure they understand both the differences and discrepancies and ensure smooth migration or clean-up as necessary. The tools available right now require manual processes to isolate these differences and eliminate them before any database migrations.
3. The ability to compare data models and database—none of the tools that exist today address this issue extensively. They suffer with issues like manual processes, which are time consuming especially when one needs to ensure all development stacks are in synch and track the migration differences and discrepancies. In most businesses there are several business data models that are deployed in single or multiple databases and schema with different release schedule. Often the database team and modeling team struggle to manage the compares and identify the discrepancies.

e. Another commonly lacking feature in all of the existing database management tools is the ability to organize the database objects within a database schema or multiple database schemas based on the business need or user reference.

Currently, none of the databases allow grouping the objects either with the same database or different database. Often the database administrators control the list of objects using database roles and grants. This approach can be used only if the users have just one role or are attached to one user group. If the users are attached to multiple user groups they are bound to see numerous objects.

This is a challenge for a business analyst or database user who deals with many databases schemas and many objects by looking at groups of objects that are aligned with a specific business function or operations.

There is a need for an effective software tool to quickly access database data and metadata, access data models, which is integrated, powerful and able to intelligently search for database and model objects, metadata and data to meet the needs of not just database users but also the business analyst, data analysts, project managers and everyone in an organization.

### SUMMARY OF THE INVENTION

The invention is directed to a computing device comprising a processor and a memory device having stored therein a plurality of instructions, which in response to be executed by the processor, cause the processor to connect to a first database, retrieve first metadata from the first database based upon a metadata retrieval policy, the metadata retrieval policy defining a set of rules for retrieving metadata from a database, and store the first metadata as a first schema view of the first database in a unified data repository, wherein the unified data repository is accessible by the computing device regardless of the current accessibility of the first database.

The step of retrieving first metadata from the first database comprises generating a plurality of contemporaneous system calls to the first database to extract metadata therefrom. In accordance with the preferred form of the invention, the policy rules define the frequency at which metadata is autonomously retrieved from the first database. The unified data repository can be stored on the computing device, or stored on a remote computing device.

The plurality of instructions in the memory device further cause the processor to disconnect from the first database, and access the unified data repository while disconnected from the first database. The plurality of instructions further cause the processor to display a user interface to a user of the computing device, and receive a request for data from the user via the user interface, in order to retrieve the first metadata from the first database based upon the request for data received from the user.

The plurality of instructions further causes the processor to connect to a second database, retrieve second metadata from the second database based on the data retrieval policy, and store the second metadata as a second schema view of the second database in the unified data repository, wherein the unified data repository is accessible by the computing device regardless of the current accessibility of the first and second databases. In this form of the invention, the plurality of instructions further cause the processor to compare the first schema view with another schema view selected from a group comprising of the second schema view, a schema view of the first database, and a schema view of the second database. Then, a report is generated of differences between the first schema view and the another schema view.

The plurality of instructions further cause the processor to generate a third schema view including database objects from the first schema view and the second schema view. Generation of the third schema view comprises generating the third schema view based on user input. The plurality of instructions further cause the processor to receive user data input, and modify at least one of the first schema view, the second schema view, and the third schema view based on the user input data.

The plurality of instructions also cause the processor to receive a search request from a user of the computing device, where the search request identifies metadata of the unified data repository, and then generate search results of the unified data repository based on the search request. Preferably, the search request includes a key word search, or a Boolean operator.

The first schema view includes one or more attributes, those attributes comprising object identifier, database identifier, parent object name, object name, object type, creation data and removal date. The plurality of instructions further cause the processor to receive a search request from a user of the computing device, the search request identifying at least one of the attributes of the first schema view, and then generate search results of the unified data repository based on the search request. Also, the plurality of instructions further cause the processor to compare the metadata stored in the unified data repository to the metadata of the first database, and generate a report of differences between the metadata stored in the unified data repository and the metadata of the first database.

In another form of the invention, it includes a method of managing a plurality of databases, each database including metadata having a plurality of database objects, with the method comprising the steps of receiving a request on a computing device to change at least one database object of a first database, then storing a tracking number associated with the request, then comparing the metadata of the first database to the metadata of a second database, then generating comparison data indicative of differences between the first database and the second database based upon the comparing step and, finally, verifying the comparison data based on the stored tracking number.

In this form of the invention, verifying the comparison data comprises matching at least one difference between the first database and the second database to the change associated with the stored tracking number. The method further comprises identifying those differences of the comparison data that do not correlate to a tracking number. In addition, the metadata of the first data base is compared to metadata of a third database, generating comparison data indicative of differences between the first data base and each of the second database and third database based on each comparing step.

A database server according to the invention comprises a database, a processor, and a memory device having stored therein a plurality of instructions, which in response to be executed by the processor, cause the processor to receive database requests from a mobile computing device over a network to access the database, process the database request using a process manager, the process manager scheduling execution of the database request to generate output data from the database, and then transmitting the output data to the mobile computing device. The plurality of instructions further cause the processor to receive modifications to a database from the mobile computing device, and modify the database based upon such modifications. Preferably, the plurality of instructions further cause the processor to store connectivity information related to the database, with the connectivity information including identification data of the mobile computing device.

### BRIEF DESCRIPTION OF THE DRAWINGS

FIG. 1 illustrates the flow of metadata, data access through REPOSITORY and LIVE modes.

FIG. 2 shows the detail about Virtual Schema creation from one or many RDBMS.

### DESCRIPTION OF EXAMPLES EMBODYING THE BEST MODE OF THE INVENTION

This invention allows database users like developers, analysts, managers, and administrators to search the database metadata, compare the database and data model objects, assimilate database schema objects into a virtual group or named object, and continuously access database metadata even during database unavailability.

The invention also provides technology and services to enable database users to manage the databases remotely using mobile application and devices.

Key features are:
1. The ability to provide a system to change the method of databases access or connection from real-time mode to offline mode and vice versa without affecting the access to the database systems through a single user interface even during DBMS unavailability.
2. A search algorithm with “AdaptiveMetaTags” that eliminates the need of writing SQL queries to database catalog and allows users to search various databases or data model repository metadata at the same time.
3. To assimilate database schema objects from similar and cross DBMS to empower users with simple yet powerful ways to access and manage databases—creation of virtual database schema by assimilating various schema objects from one or more DBMS.
4. A sophisticated way of comparing database objects of one or many databases from similar and cross DBMS, data models that provide a single report in a horizontal view of the entire databases, models using simplified report legends concept and the ability to resolve discrepancies and suppress them for future reports.
5. Database management applications for mobile devices through web and operating system services.

1. Unified Method of Accessing Real-Time and Offline Databases and Data Models

This asset of the invention provides a mechanism to access database metadata real-time as well as in an offline mode by creating a unified database metadata repository from one or more DBMS systems (Example: Oracle, My SQL, DB2, SQL Server, Sybase, and Terradata) and data models; and the ability to change the method of databases access or connection from real-time mode to offline mode and vice versa without affecting the access to the database systems through a single user interface even during DBMS unavailability.

The database users can connect to any RDBMS by providing the necessary username and password that has the privilege to access the specific RDBMS. This enables users to access the data and metadata directly from the RDBMS that is connected. This method is referred as the “LIVE” access mode. But if the RDBMS is unavailable or not running, users won't be able to access the metadata or data. The invention addresses this specific problem by allowing the users to create their own unified repository which can be accessed even in the situation of RDBMS unavailability. This is called “Repository Access Mode” or “Offline Mode”. User can control and schedule the frequency to collect the metadata from various RDBMS or database models into this unified metadata repository.

Based on the username and password provided by the database user, metadata is retrieved from various DBMS and data models into the unified metadata repository. The unified metadata repository can be a local repository which is private to particular database user or can be a Server repository which can be accessed by many individual users or entity or application. This provides the ability to control database access by providing read only access to this unified repository of various databases and data models that exist in an organization without providing actual access to the underlying databases or data model.

Unlike traditional sequential database connection and retrieval by various tools, the invention intelligently splits the database metadata collection process into numerous system calls simultaneously. Depending on the user's request through an interface and or using database refresh schedule as defined by the user, the system calculates the number of objects types needed to be retrieved and the time required to retrieve them. It system then splits database catalog collection process into numerous call packages. For example, there are many different object types are there in any RDBMS like Tables, Indexes, Constraints, Views etc. The calls are split for each object type and run simultaneously to collect the metadata from various databases or data model repositories.

This method of distributed and simultaneous catalog collection process is transparent to the user but the results will be produced through the interface very quickly.

This method has wide range of applications. Organization or users who access database through internet or mobile application, or users don't require real-time catalog information can fully exploit the power of “Repository Mode” and switch to “LIVE” mode only if absolutely necessary.

The two different access modes available to database users are:

Live Access Mode:

Through a user-friendly graphical interface, database users use the database metadata explorer to establish connections to different databases in a unified repository. The database metadata is instantly received, processed and displayed through the repository that brings up both last and simultaneous live metadata to enable the fastest access to database metadata.

Repository Access Mode:

Through a user-friendly graphical interface, database users can continue to access database metadata through previously and continuously refreshed catalog information from unified metadata repository.

2. Search Engine

This aspect of the invention provides a search algorithm with “AdaptiveMetaTags” that eliminates the major need of writing SQL queries to database catalog to retrieve the information and allows users to search various databases or data model repository metadata at the same time.

It comprises a search algorithm that uses a new system called “AdaptiveMetaTags” (Tags are explained in detail below) to help identify and match a given search string and produce the database metadata results without typing any single SQL command. The algorithm translates the user input and calculates the location and objects, based on the keyword-based search combined with database attribute name search to calculate and produce the results. Previous methods of executing SQL commands, used by many search engines, were once more popular but are now obsolete, slow and hard to use and require expert knowledge.

The search process accesses the actual database in LIVE access mode to search the criteria or accesses the unified metadata repository to search various database or data model metadata at the same time.

The possible ways available to users to search the database or data model are described below.

Users can provide any specific search format or “Adaptive Meta Tags” to search in the databases or data model repository.

The database catalog from the database and data models are maintained in a simplified format when the catalog data is collected each time. The data store called the “Adaptive Data Store” stores data in an extremely simple format. Table-1 below depicts a sample typical data format and the attributes are not limited only to this one and many attributes can be added to this sample format.

TABLE 1

| | Attribute | Definition |
|---|---|---|
| 1 | Object Identifier | A unique object identified |
| | | for each database object |
| 2 | Database/Model | Database or Model name identifier |
| | Identifier | |
| 3 | Table or Parent | Table Name or parent object name |
| | Object Name | |
| 4 | Object Name | Dependent database or model object name |
| 5 | Object Type | A code identifying type of database object |
| 6 | Start Date | The date/time object created in unified repository |
| 7 | End Date | The date/time the new version received or this |
| | | record is retired from the repository. |

The search algorithm looks for keywords (see Adaptive Meta Tags below), object properties (values of an attribute like Unique or Bitmap Index, Valid or Invalid status etc.) and words within database column name. For example, a user can simply enter a column name in one of the catalog table as “Last DDL Time” or “DDL Time”, and the search function will then scan through the possible match within the catalog or Adaptive Data Store (Table-1) and look for the possible match. It has an option for users to add their own adaptive meta tags as well.

The algorithm then determines the approach and path and conditionality (equal, greater, less than or wild cards) to join catalog tables for which the search is requested and produces the result to the end user.

Below are advanced indexing techniques used on the data in Table-1 to achieve faster search results:

Search Format:
<KeyWord>=[Value],[ObjectProperty]=[Value] , [Attribute List/*]

| | | | |
|---|---|---|---|
| | | Signs | |
| Search Operator | | = | Equal Sign |
| | | <> | Not Equal Sign |
| | | != | |
| | | > | Greater Sign |
| | | < | Lesser Sign |
| Property Delimiter | The Property | , | Comma Sign |
| | Delimiter can be | | |
| | used to separate | | |
| | the object | | |
| | properties in the | | |
| | search term | | |
| Search Conditionality | Use this as a wild | % | Percent Sign |
| | card either before | | |
| | and/or after a | | |
| | word. | | |
| | | Keywords | |
| Adaptive Meta Tags. | | SRVR | Indicates the server level |
| The metadata tags are | | | objects |
| generic keywords that | | DB | Indicates the database |
| can be used to query | | | level objects |
| consistently across any | | SCMA | Indicates the schema level |
| database. | | | objects |
| | | SYS | (Indicates the SYS or super |
| | | | database user objects) |
| | | CLU | Database Cluster |
| | | LINK | Database Links |
| | | DIR | Database Directories |
| | | LIB | Database Libraries |
| | | OUT | Database Outlines |
| | | PFL | Database Profile |
| | | SEG | Rollback Segments |
| | | USR or | Schema owner or database |
| | | OWN | user |
| | | JOB | Database Jobs |
| | | OBJ | (All Schema Objects) |
| | | ALLTAB | All Tables objects |
| | | | including dependents |
| | | CK[ey] | Check Constraint |
| | | FK[ey] | Foreign Key |
| | | PK[ey] | Primary Key |
| | | UK[ey] | Unique Key |
| | | IDX | Index |
| | | COL | Column |
| | | MV | Materialized View |
| | | MVL | Materialized View Logs |
| | | TAB | Tables |
| | | VEW | View |
| | | PRO | Procedures |
| | | PKG | Package |
| | | PKGB | Package Body |
| | | ROLE | Role |
| | | SEQ | Sequence |
| | | SYN | Synonym |
| | | TRG | Trigger |
| | | TYP | Type |
| | | TYPB | Type Bodies |
| | | TS | Table Space |
| | | BP | Buffer pool |

Object Properties can be used in the search:
Search Format:
   <Property Type>=[Value (Both Abbreviated or Actual)]

Index Type: TYPE Values: NU (Non Unique), UQ (Unique), BX (Bitmap)

Index Status: STAT (Status), VLD (Valid)
Column: LEN (Length), SCALE (Scale), TYPE (Data Type), NULL (Null), NN (Not Null)

Commands: (For example, DESC <OBJECT>)

### EXAMPLES

a. To search all tables and views with name ending_temp.
TAB VEW=%_temp

b. To search name ‘AMT’ in all columns for the owner public and database name is product with precision >3 and table names not like ‘temp’. Also show all attributes of Column.
DB=product OWN=public COL=% AMT %, scale>3, *TAB<>% temp %

c. Find all invalid non unique indexes
IDX TYPE=NU, VLD=0

The search keywords and properties are constantly updated or customized by users to achieve best search results quickly.

3. Virtual Schema

This aspect of the invention is to assimilate database schema objects from similar and cross DBMS to empower users with simple yet powerful ways to access and manage databases—creation of virtual database schema by assimilating various schema objects from one or more DBMS.

In database, a schema is a collection of database objects like Tables, Constraints, Views, Indexes, Packages, Procedures and Functions etc. The invention provides the ability to database users create a “Virtual Schema” that is composed of various schema objects. Unlike database schema, Virtual Schema is either a subset of a Schema or objects that combine several of the schema objects from a single to multiple relational databases. A Virtual Schema is not part of the physical schema: it is a dynamic, virtually collated from live database catalog or unified metadata repository.

The virtual schema is implemented by storing the definitions (abstract) of the objects with characteristics and rules below. Any changes to the underlying objects are reflected in the virtual schema.

Since the Virtual Schema is an abstract of underlying objects that are grouped, the information can be easily exchanged between the users and can be further extended as needed.

a. Virtual Schema can be subset the database objects in same or several schemas.

b. Virtual Schema can join multiple objects from a single or several databases.

c. Virtual Schema can hide the complexity of database, for example a Virtual Schema could appear as Product, Sales or Accounts transparently partitioning the actual underlying schema objects.

d. Virtual Schema can provide additional security and controls to the administrators.

e. Virtual Schema can limit the exposure to which a table or tables are exposed to the outer world, just like functions (in programming) provide abstraction; Virtual Schema can be used to create abstraction.

f. Virtual Schema can be used just as database schema and users can manage these objects, back-up and refresh to provide filtered objects lists with latest catalog data.

Database users can easily and quickly create, manage Virtual Schema through an interface provided through the tool. They can also simply TAG a database object from the list and add it to a Virtual Schema.

4. Schema Compare

This aspect of the invention provides a sophisticated way of comparing database objects of one or many databases from similar and cross DBMS, data models that provide a single report in a horizontal view of the entire databases, and models using simplified report legends concept, and the ability to resolve discrepancies and suppress them for future reports.

This compare process, unlike any other tool, compares multiple models and database schemas similar or different DBMS and provides a comprehensive view of both differences and discrepancies.

It provides a feature to compare tables, views, functions, sequences, packages, stored procedures etc. and properties between two or many schemas/databases. It reports any discrepancies between schemas. The comparison can be done between schemas on two or more DBMS platforms such as Oracle, My SQL, SQL Server, and DB2 etc.

The Schema Compare process implements state-of-the-art technology to report most complex database comparison, which is model comparison. The Schema compare can list and group the differences across for easy viewing—an interactive, powerful, simple and quick way to identify differences, and select/deselect objects to migrate and generate DDL.

The compare process can compare a live database to a live or snapshot or offline catalog. It helps DBAs (Database Administrators) ensure smooth migration and comply with standards, and maintain overall database quality.

The compare process also offers a new feature that can compare data models like Erwin and ER/STUDIO etc with databases. It provides a system that can directly interface with data model server repositories, can extract the schema information and compare it against different models or databases.

The compare process provides two unique features. The process provides integration with Change management systems and the option to resolve the differences when first reported and identify them as a migrating change or not.

The change management integration approach involves capturing or importing data from change management systems in a pre-defined format.

The structure change against each database object is tracked with its tracking number. The information is then used to match-up against the differences reported during the compare process. If database structure changes due to an approved change management request and has a tracking number, this information is analyzed and reported as migrating changes and not as a difference.

This information is very useful for project managers, change management people and for everyone who at any point can clearly isolate and identify migrating changes between potential unwanted changes that exist in the database.

In addition to change management or where the integration is not possible, users can also resolve differences and stamp them as a migrating change with a tracking number interactively in a schema compare report. This information is used to continuously report discrepancies. Following are the some of the salient features:

Interactive and Powerful Reporting:

One tool for database/model compares that can be customized and used interchangeably.

Customize comparison reports to align with business and other operational needs; compare can be performed against Virtual Schema to represent and address specific needs.

Ability to identify and resolve the discrepancies interactively and mark them not to appear in future reports—A unique feature for change management and baseline migrations.

Improve Productivity and Accuracy:

The compare features offers solutions to some traditionally problematic issues, particularly, how to migrate database changes and synchronize development activities within rapid and dynamic development cycle.

The inbuilt automated schedule and delivery functionality can be used to resolve discrepancies due to frequent database refreshes and or structure migrations.

The tool provides application interface to schedule and deliver the compare reports during or after database refreshes.

5. Manage and Access RDBMS from Mobile Devices.

This aspect of the invention provides a database management application for mobile devices through web and operating system services.

This involves two major components:
a. A mobile application that resides on popular smart phones like Blackberry and iPhone etc.
b. Web Service with application software that
   a. Authenticates users
   b. Stores information about database connectivity information, user options and configuration.
   c. Accepts database requests from the mobile users
   d. Has a process manager that schedules the requests and executes.
   e. Returns response to the users through email or page.

A web service application is implemented that captures information about organizations' database connectivity information, system information, with options to control user access and configurations.

The web service software is programmed to receive requests from the users through a mobile device. The requests are either previously defined tasks with option or SQL commands. When the request is received by the web service system, it is authenticated and accepted by the system and confirmation is sent to the mobile users with process identification or job number.

The mobile application is used to send the database task request to the web service located and running in an organization. The mobile application enable users to request a database task to be executed, search database objects and even execute a SQL command on any database configured in web service in few strokes.

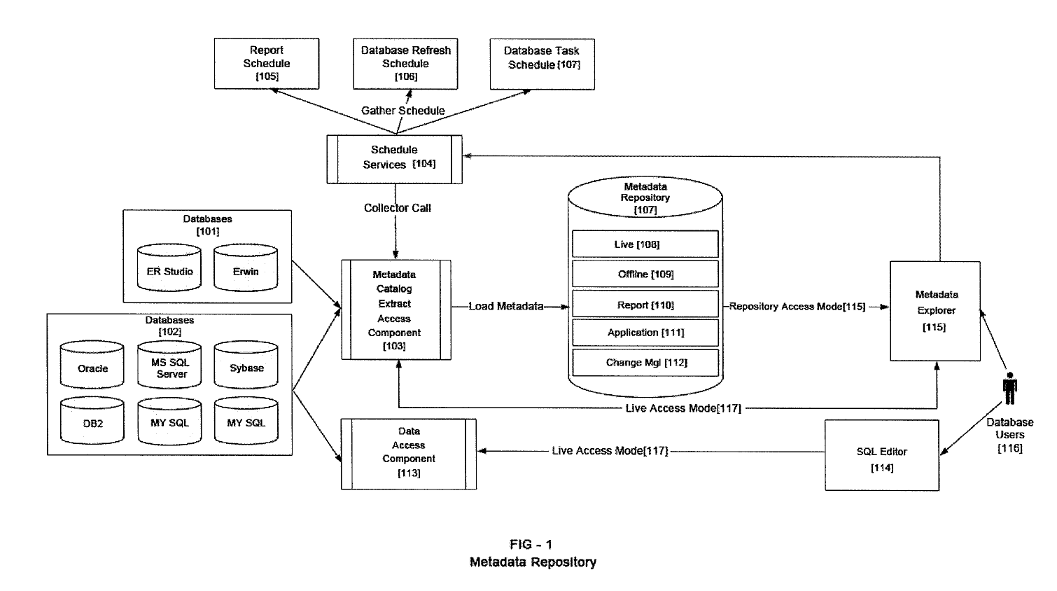

FIG. 1—Metadata Repository:

FIG. 1 illustrates the database or data model metadata repository access and storage and retrieval process.

The user 116 schedules database or data model refreshes. The schedule services 104 constantly look for requests from the Reports Scheduler 105 databases scheduler 106 and database task scheduler 107. The schedule services 104 then invokes Metadata Catalog extract component 103.

The purposes of Metadata Catalog extract component 103 is to understand the priority of the request, calculate the time needed to completed the request and find best possible method to finish the request.

The Metadata Catalog extract component 103 makes connections to the databases or data model repository using either native database drivers or ODBC drivers that are already configured and saved by the user for each databases. Once the connection is established with the database the Metadata Catalog extract component 103 makes simultaneous calls to the databases 102 or data models 101 to retrieve object schema objects and system object information. The information retrieved from the database is then process stored in a proprietary Unified Metadata Repository database for faster storage and retrieval.

The Metadata Repository database contains multiple segments or partitions 108, 109,110,111 and 112 depending on the type of user access mode by user 116.

Once the data is ready either by directly requesting it through Live Access Mode 117 or through schedule services 104, the user 116 can access the entire database 102 or data model 101 catalog information using metadata explorer 115, a user interface.

The metadata explorer 115 also provides various tools and features to empower users not just access but search, objects compare, generate various quality, monitoring reports and manage database objects.

The user can also use another development environment to access database, the SQL Editor 114. The SQL Editor uses native connectivity or ODBC connectivity drivers to connect to the database. The editor is can be used to develop band manage database using SQL commands.

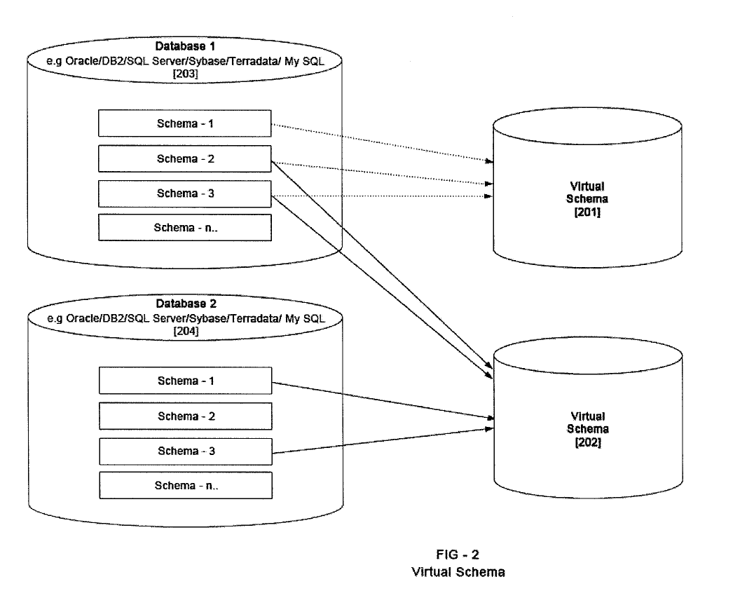

FIG. 2—Virtual Schema:

Virtual Schema is a collection of database schema objects from one or more similar or cross databases. The schema objects like tables, views, procedures, and functions can be assimilated into a meaningful group.

In FIG. 2 the Virtual Schema 201 reflect objects from more than one schema from a database are grouped. Once the virtual schema is created this can be used just like any other database schema from the tool to access catalog, retrieve data and even manage those objects.

The Virtual Schema 202 is another example of how this can be derived from multiple schemas from different databases. This is a very powerful feature for business and database users which enables them to focus on their object they need.

### Sample Tool Features

The list of inventions and features described above can be implemented through a multi-platform database management tool that provides rich user interface and functionality to help users to achieve their goals.

The tool features:

1. Support for Multiple Operating Systems
The tool supports multiple operating systems, including Windows XP, Vista, Windows 2000/NT, Windows 7, Mac OS x and Embedded Linux etc.

2. Database Explorer

The tool provides database access though its explorer both real-time and offline through a user interface with powerful search, productivity, quality, compare and reporting with rich features for database object management. It allows users to create snapshot copy of metadata at any particular time and name it to use it later for various business purposes

3. Model Explorer

The model repository embedded in the tool allows both real-time and offline collaboration between modelers who want to ensure its consistency. Database users, application users who would like to access model data dictionary, definitions and compare them against database.

The tool also provides features to manage and monitor corporate data model compliance and data model quality.

4. Schema and System Objects Compare

The tool offers features to instantly compare the objects across the databases, and model in addition to extended powerful compare feature that can be managed and organized.

It also provides detailed discrepancy reports that increase productivity by accelerating the review process. The innovative report “legends” and “resolve” feature isolates specific discrepancies between the databases, models, eliminating the task of finding the problem in large and complex structure.

5. Search

The tool uses new algorithm called “AdaptiveMetaTags” to help identify and match a given search string and produce the database metadata results without typing any single SQL command.

The search uses a technique similar to popular search engines and generates search results based on pre-defined tags and proprietary mappings and an algorithm that identifies the intention of the user's requests and produces the catalog result.

6. Virtual Schema

Database users can combine the schema objects across the databases into a meaningful group called “Virtual Schema” that provides unlimited features including, simultaneous access, compare databases against virtual schema, refresh the virtual schema individually, baseline and search.

Various changes can be made to the invention without departing from the spirit thereof or scope of the following claims.

What is claimed is:

1. A computing device comprising:
a processor; and
a memory device having stored therein a plurality of instructions, which in response to be executed by the processor, cause the processor to:
connect to a first database;
retrieve first metadata from the first database based on a metadata retrieval policy, the metadata retrieval policy defining a set of rules for retrieving metadata from a database; and
store the first metadata as a first schema view of the first database in a unified data repository, wherein the unified data repository is accessible by the computing device regardless of the current accessibility of the first database.

2. The computing device of claim 1, wherein to retrieve first metadata from the first database comprises to generate a plurality of contemporaneous system calls to the first database to extract the metadata therefrom.

3. The computing device of claim 1, wherein the policy rules define the frequency at which metadata is autonomously retrieved from the first database.

4. The computing device of claim 1, wherein the unified data repository is stored on the computing device.

5. The computing device of claim 1, wherein the unified data repository is stored on a remote computing device.

6. The computing device of claim 1, wherein the plurality of instructions further cause the processor to:
disconnect from the first database; and
access the unified data repository while disconnected from the first database.

7. The computing device of claim 1, wherein the plurality of instructions further cause the processor to:
display a user interface to a user of the computing device; and
receive a request for data from the user via the user interface,
wherein to retrieve the first metadata from the first database comprises to retrieve the first metadata from the first database based on the request for data received from the user.

8. The computing device of claim 1, wherein the plurality of instructions further cause the processor to:
connect to a second database;
retrieve second metadata from the second database based on the data retrieval policy; and
store the second metadata as a second schema view of the second database in the unified data repository, wherein the unified data repository is accessible by the computing device regardless of the current accessibility of the first and second databases.

9. The computing device of claim 8, wherein the plurality of instructions further cause the processor to:
compare the first schema view with another schema view selected from the group consisting of: the second schema view, a schema view of the first database, and a schema view of the second database; and
generate a report of differences between the first schema view and the another schema view.

10. The computing device of claim 1, wherein the plurality of instructions further cause the processor to generate a third schema view including database objects from the first schema view and from the second schema view.

11. The computing device of claim 10, wherein to generate the third schema view comprises to generate the third schema view based on user input.

12. The computing device of claim 11, wherein the plurality of instructions further cause the processor to:
receive user input data; and
modify at least one of the first schema view, the second schema view, and the third schema view based on the user input data.

13. The computing device of claim 1, wherein the plurality of instructions further cause the processor to:
receive a search request from a user of the computing device, the search request identifying metadata of the unified data repository; and
generate search results of the unified data repository based on the search request.

14. The computing device of claim 13, wherein the search request includes a keyword search.

15. The computing device of claim 13, wherein the search request includes a Boolean operator.

16. The computing device of claim 1, wherein the first schema view includes one or more of the following attributes: object identifier, database identifier, parent object name, object name, object type, creation data, and removal date.

17. The computing device of claim 16, wherein the plurality of instructions further cause the processor to:
receive a search request from a user of the computing device, the search request identifying at least one of the attributes of the first schema view; and
generate search results of the unified data repository based on the search request.

18. The computing device of claim 1, wherein the plurality of instructions further cause the processor to:
compare the metadata stored in the unified data repository to the metadata of the first database; and
generate a report of differences between the metadata stored in the unified data repository and the metadata of the first database.

19. A method of managing a plurality of databases, each database including metadata having a plurality of database objects, the method comprising:
receiving a request on a computing device to change at least one database object of a first database;
storing a tracking number associated with the request;
comparing the metadata of the first database to metadata of a second database;
generating comparison data indicative of differences between the first database and the second database based on the comparing step; and
verifying the comparison data based on the stored tracking number.

20. The method of claim 19, wherein verifying the comparison data comprises matching at least one difference between the first database and the second database to the change associated with the stored tracking number.

21. The method of claim 19, further comprising identifying those differences of the comparison data that do not correlate to a tracking number.

22. The method of claim 19, further comprising comparing the metadata of the first database to metadata of a third database,
wherein generating comparison data comprises generating comparison data indicative of differences between the first database and each of the second database and the third database based on each comparing step.

23. A database server comprising:
a database;
a processor; and
a memory device having stored therein a plurality of instructions, which in response to be executed by the processor, cause the processor to:
receive database requests from a mobile computing device over a network to access the database;
process the database request using a process manager, the process manager scheduling execution of the database request to generate output data from the database; and
transmitting the output data to the mobile computing device.

24. The database server of claim 23, wherein the plurality of instructions further cause the processor to:
receive modifications to a database from the mobile computing device; and
modify the database based on such modifications.

25. The database server of claim 23, wherein the plurality of instructions further cause the processor to store connectivity information related to the database, the connectivity information including identification data of the mobile computing device.
